(19) United States
(12) Patent Application Publication
(10) Pub. No.: US 2025/0016886 A1
(43) Pub. Date: Jan. 9, 2025

(54) COMMUNICATION TERMINAL DEVICE AND COMPUTER-READABLE STORAGE MEDIUM

(71) Applicant: JVCKENWOOD Corporation, Yokohama-shi (JP)

(72) Inventor: Reo Hasegawa, Yokohama-shi (JP)

(21) Appl. No.: 18/889,436

(22) Filed: Sep. 19, 2024

Related U.S. Application Data
(63) Continuation of application No. PCT/JP2023/005205, filed on Feb. 15, 2023.

(30) Foreign Application Priority Data
Mar. 28, 2022 (JP) 2022-052100

(51) Int. Cl. H04W 76/45; H04W 72/0453

(52) U.S. Cl. CPC H04W 76/45; H04W 72/0453

(57) ABSTRACT

A communication terminal device includes a radio and a portable terminal device connected to the radio. The radio includes: a radio-side storage storing setting information used for radio communication with another radio; and a radio-side communication unit executing group communication with the other radio based on the setting information. The portable terminal device includes: an information exchange unit acquiring, from a portable terminal device of another communication terminal device, setting information on a radio connected to the portable terminal device of the other communication terminal device; a portable-terminal-device-side storage storing the acquired setting information on the radio of the other communication terminal device; a setting information generator generating new setting information based on the setting information stored in the radio-side storage and the setting information stored in the portable-terminal-device-side storage; and an information setting unit updating the setting information stored in the radio-side-storage based on the generated new setting information.

### CROSS-REFERENCE TO RELATED APPLICATIONS

This application is a Continuation of PCT International Application No. PCT/JP2023/005205 filed on Feb. 15, 2023 which claims the benefit of priority from Japanese Patent Application No. 2022-052100 filed on Mar. 28, 2022, the entire contents of both of which are incorporated herein by reference.

### BACKGROUND

The present disclosure relates to a communication terminal device and a computer-readable storage medium.

A data write system of an in-vehicle electronic control unit that performs radio communication between a radio communication device outside a vehicle and an in-vehicle transceiver has been proposed (for example, Japanese Laid-open Patent Publication No. 2010-19175). In this system, the radio communication device receives vehicle information on each vehicle via the transceiver and specifies a vehicle to be subject to data writing, based on the received vehicle information. The radio communication device transmits data to be written to the specified vehicle via the transceiver. The data to be written is a program of a new version.

According to Japanese Laid-open Patent Publication No. 2010-19175, however, because the data to be written is the program of the new version that is already determined, the data to be written is transmitted to only a specific vehicle that is subject to the data writing. In other words, it is not possible to transmit the data to be written to a vehicle of a different specification.

In an emergency, such as a disaster, different groups gather and communicate using radios in some cases. In this case, the frequency used by the radios or the specification of the radios differs in each group in some cases. For this reason, when different groups gather and perform a cooperative work, while it is necessary to standardize the frequency of the radios, there is a difficulty in making a setting for standardizing the frequency that is used on site and it is difficult to make a prompt establishment of a communication environment between the groups. In other words, while it is necessary to transmit setting information for setting a frequency, etc., to radios of different specifications, it is difficult to realize the transmission using the techniques disclosed in Japanese Laid-open Patent Publication No. 2010-19175.

### SUMMARY

A communication terminal device according to the present disclosure includes: a radio; and a portable terminal device that is connected to the radio. The radio includes: a radio-side storage unit that stores setting information that is set for performing radio communication with another radio; and a radio-side communication unit that executes group communication with the other radio based on the setting information. The portable terminal device includes: an information exchange unit that acquires, from a portable terminal device of another communication terminal device, setting information on a radio that is connected to the portable terminal device of the other communication terminal device; a portable-terminal-device-side storage unit that stores the setting information on the radio of the other communication terminal device that is acquired by the information exchange unit; a setting information generator that generates new setting information based on the setting information stored in the radio-side storage unit and the setting information stored in the portable-terminal-device-side storage unit when the setting information stored in the portable-terminal-device-side storage unit satisfies a given condition; and an information setting unit that updates the setting information stored in the radio-side-storage unit of the radio based on the new setting information that is generated by the setting information generator.

A computer-readable storage medium according to the present disclosure stores a setting information editing program that is executed by a portable terminal device connected to a radio and that is for editing setting information set to perform radio communication with another radio. The program causes the portable terminal device to execute: acquiring, from a portable terminal device of another communication terminal device, setting information on a radio that is connected to the portable terminal device of the other communication terminal device; storing the setting information acquired from the radio connected to the portable terminal device of the other communication terminal device; generating new setting information based on the setting information on the radio and the stored setting information when the stored setting information satisfies a given condition, and updating the setting information on the radio based on the generated new setting information.

### BRIEF DESCRIPTION OF THE DRAWINGS

FIG. 1 is a block diagram illustrating a communication system including communication terminal devices of the present embodiment;

FIG. 2 is a block diagram illustrating the communication terminal device of the present embodiment;

FIG. 3 is an illustration illustrating a configuration of users who use the communication system;

FIG. 4 is a flowchart illustrating a process performed by the communication terminal devices of the present embodiment; and

FIG. 5 is a diagram of a group list that is generated newly.

### DETAILED DESCRIPTION OF THE PREFERRED EMBODIMENTS

An embodiment of a communication system and a setting information editing program according to the present disclosure will be described in detail below according to the drawings. Note that the embodiment does not limit the present disclosure.

### EMBODIMENT

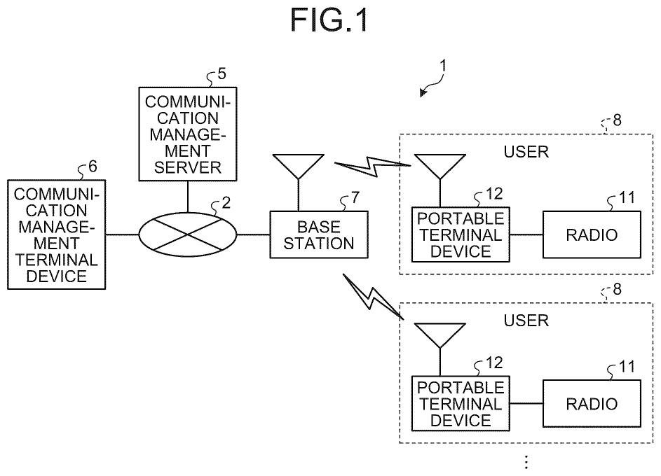

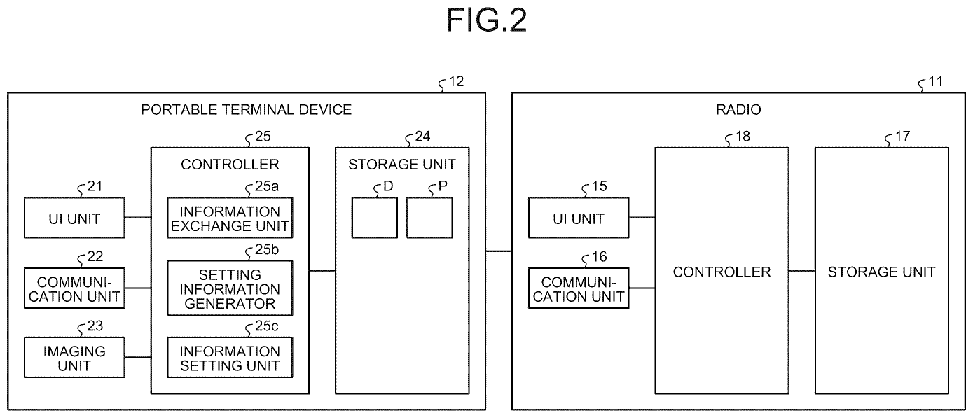

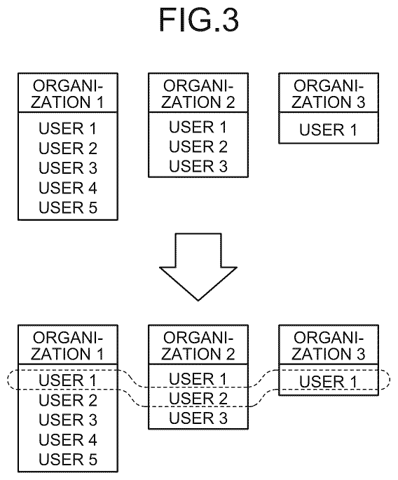

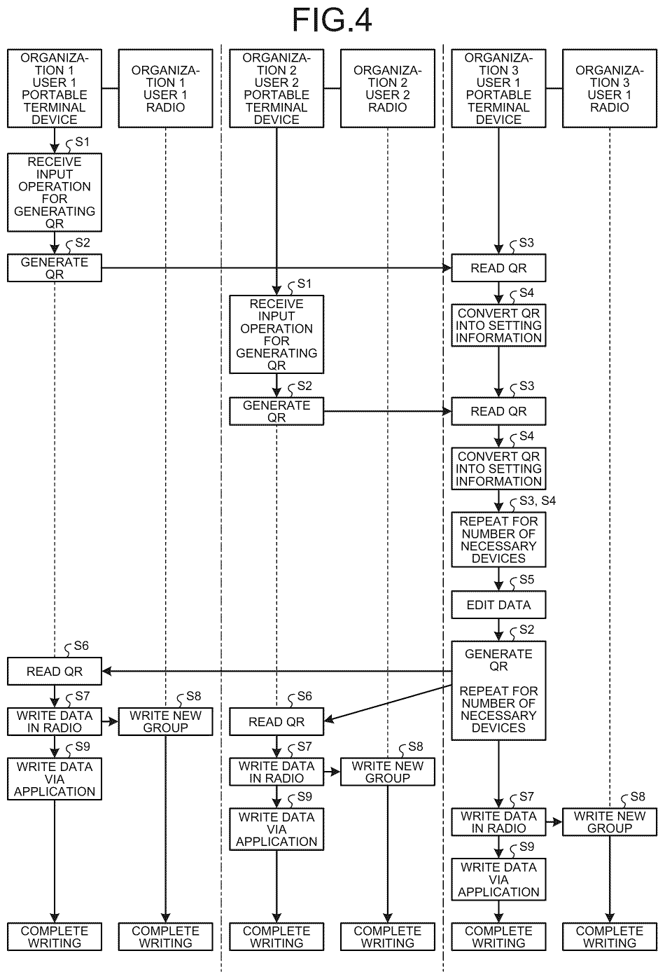

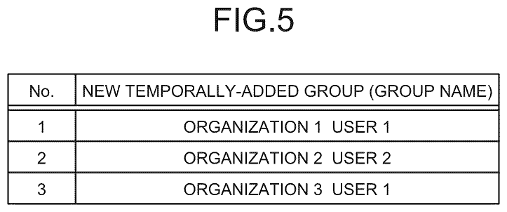

FIG. 1 is a block diagram illustrating the communication system including communication terminal devices of the present embodiment. FIG. 2 is a block diagram illustrating the communication terminal device of the present embodiment. FIG. 3 is an illustration illustrating a configuration of users who use the communication system. FIG. 4 is a flowchart illustrating a process performed by the communication terminal devices of the present embodiment. FIG. 5 is a diagram of a group list that is generated newly.

### Communication System

The communication system 1 of the embodiment including communication terminal devices 8 is a system in which the communication terminal devices 8 perform radio communication mutually. As illustrated in FIG. 1, the communication system 1 includes a communication network 2, a communication management server 5, a communication management terminal device 6, a relay device 7, and the communication terminal devices 8.

The communication network 2 is the Internet and the communication management server 5, the communication management terminal device 6, and the relay device 7 are connected via the communication network 2 such that they can communicate with each other.

The communication management server 5 is, for example, Push-to-Talk over Cellular (PoC) server. The communication management server 5 records communication information on the communication terminal devices 8 used in the communication system 1, performs communication control, and controls a setting on radio communication. The communication management server 5 is connected to the communication network 2 and communicates with the communication terminal devices 8 via the relay device 7.

The communication management terminal device 6 is, for example, a personal computer (PC) terminal device. The communication management terminal device 6 performs management on radio communication between the communication terminal devices 8 used in the communication system 1 and performs management on the setting on the communication terminal devices 8. The communication management terminal device 6 is connected to the communication network 2 and performs communication with the communication terminal devices 8 via the relay device 7.

The relay device 7 is, for example, a base station, or the like. The relay device 7 relays radio communication between the communication management server 5 and the communication management terminal device 6 and the communication terminal devices 8. The relay device 7 is connected to the communication network 2 and transmits and receives various types of information between the communication management server 5 and the communication management terminal device 6 and the communication terminal devices 8.

### Communication Terminal Device

With reference to FIGS. 1 and 2, the communication terminal device 8 will be described next. The communication terminal device 8 includes a radio 11 and a portable terminal device 12 connected to the radio 11. The communication terminal device 8 is assumed to be, for example, a terminal device used in an emergency, such as a disaster. Under an emergency, groups consisting of users who use the communication terminal devices 8 gather. The gathering groups are different groups (i.e., groups belonging to different organizations) and thus the radios 11 used in the communication system 1 are different from each other in setting information that are set to perform radio communication. The setting information is, for example, information containing a type of a communication method, a usable frequency band, a group name of the radios 11, and the name of the individual radio 11. When different groups gather and perform a cooperative work, the communication terminal devices 8 are capable of exchanging the setting information between the terminal devices because it is necessary to standardize the setting information on the radios 11.

The radio 11 includes a user interface (UI) unit 15, a communication unit 16, a storage unit 17, and a controller 18. The communication unit 16 is also referred to as a radio-side communication unit, and the storage unit 17 is also referred to as a radio-side storage unit. The UI unit 15 receives an input operation from the user and outputs information to the user. The UI unit 15 is, for example, an operation unit, such as a switch and a button, a display, such as a liquid crystal panel and an organic EL panel, a speaker, a microphone, etc. The UI unit 15 acquires an input from the operation unit, displays data that is processed on the display, outputs sound from the speaker, and acquires an audio input from the microphone. The communication unit 16 performs radio communication with another radio 11 and performs radio communication and wired communication with the connected portable terminal device 12. The communication unit 16 performs radio communication with a plurality of other radios 11 that are grouped. The communication unit 16 is, for example, a radio communication module and a wired module and, specifically, a ground radio communication unit, a USB communication unit, a Bluetooth (trademark) communication unit, etc.

The storage unit 17 stores various types of information. The storage unit 17 is, for example, a storage device, such as a semiconductor memory device, such as a random access memory (RAM), a read only memory (ROM), or a flash memory. The storage unit 17 may be an external storage device that is connected in a wired or wireless manner. The storage unit 17 stores setting information on the radio 11, etc., as one of the various types of information. The controller 18 controls operations of each unit of the radio 11. The controller 18 performs communication control on the communication unit 16, display control on the UI unit 15, operation control on the UI unit 15, and audio control on the UI unit 15. The controller 18 is, for example, an integrated circuit, such as a central processing unit (CPU). The controller 18 executes write control based on the setting information in an operation flow of the communication terminal device 8 illustrated in FIG. 4.

The portable terminal device 12 includes an UI unit 21, a communication unit 22, an imaging unit 23, a storage unit 24, and a controller 25. The communication unit 22 is also referred to as a portable-terminal-device-side communication unit, and the storage unit 24 is also referred to as a portable-terminal-device-side communication unit. The UI unit 21 is approximately the same as the UI unit 15 of the radio 11, and the UI unit 21 may further include a touch panel display. The communication unit 22 performs radio communication with another portable terminal device 12 via the relay device 7 and performs radio communication and wired communication with the radio 11 connected thereto. The communication unit 22 is, for example, a radio communication module and a wired communication module and is specifically a portable communication unit, an USB communication unit, a Bluetooth (trademark) communication unit, a Wi-Fi (trademark) communication unit, or the like.

The imaging unit 23 acquires an image by capturing an image of a subject. The imaging unit 23 is, for example, a camera. The imaging unit 23 captures an image of, for example, the display in the UI unit 21 of another portable terminal device 12 as the subject in the process illustrated in FIG. 4 as the subject.

The storage unit 24 stores various types of information D and various types of programs P. The storage unit 24 is, for example, a storage device, such as a semiconductor memory device, such as a random access memory (RAM), a read only memory (ROM), or a flash memory. The storage unit 24 may be an external storage device that is connected in a wired or wireless manner. The storage unit 24 stores, as the various types of information D, for example, setting information that is acquired or generated by the portable terminal device 12, image information obtained by capturing an image by the imaging unit 23, a two-dimensional code that is generated based on the setting information, etc. The storage unit 24 stores, as the programs P, the setting information editing program for editing the setting information on the radio 11, a program for executing image capturing by the imaging unit 23, a program for voice call between the portable terminal devices 12 (voice call application), etc.

The controller 25 controls operations of each unit of the portable terminal device 12. Like the controller 18 does, the controller 25 performs communication control on the communication unit 22, display control on the UI unit 21, operation control on the UI unit 21, and audio control on the UI unit 21. The controller 25 performs image-capturing control on the imaging unit 23. The controller 25 is, for example, an integrated circuit, such as a central processing unit (CPU). The controller 25 executes an information exchange process, a setting information generation process, and an information setting process in the flow of operations of the communication terminal device 8 illustrated in FIG. 4. The information exchange process, the setting information generation process, and the information setting process will be described below.

The controller 25 executes the information exchange process via the UI unit 21. The information exchange process is a process of executing exchange of the setting information on the radio 11 with the portable terminal device 12 of another communication terminal device 8. Specifically, when providing, to another portable terminal device 12, information concerning the setting information on the radio 11, the controller 25 acquires the setting information on the radio 11 from the storage unit 24, generates a two-dimensional code (e.g., QR code) containing the setting information, and displays the generated two-dimensional code on the display of the UI unit 21. On the other hand, when acquiring information concerning the setting information on the radio 11 of another portable terminal device 12, the controller 25 reads a two-dimensional code displayed on the display of the UI unit 21 of the other portable terminal device 12 to acquire the setting information contained in the read two-dimensional code. The controller 25 stores the acquired setting information in the storage unit 24. As described above, the controller 25 functions as an information exchange unit 25a that executes the information exchange process and specifically functions as a code information exchange unit that executes the information exchange process using a two-dimensional code.

The controller 25 executes the information exchange process via the UI unit 21; however, the controller 25 is not particularly limited to this configuration. The controller 25 may execute the information exchange process via the communication unit 22. In other words, the communication unit 22 may be configured to perform information exchange of the setting information on the radio 11 with radio communication, whereby the controller 25 functions as a radio information exchange unit. Alternatively, the communication unit 22 may be configured to perform information exchange of the setting information on the radio 11 with wired communication, whereby the controller 25 functions as a wired information exchange unit.

The controller 25 executes the setting information generation process by executing the setting information editing program. The setting information generation process is a process of generating new setting information based on setting information acquired from another portable terminal device 12 and setting information of its own device 12 that is set previously and stored in the storage unit 24. As described above, the controller 25 functions as a setting information generator 25b that executes the setting information generation process. As an example of the setting information generation process, the controller 25 may set a new frequency as the setting information after excluding unusable frequency bands based on a usable frequency band according to the specifications of the radios 11. The controller 25 may set, as the setting information, a new frequency different from the frequency bands that are used by Organizations 1 to 3, which will be described later. Furthermore, the controller 25 may set, as the setting information, new frequencies containing a frequency band that is used in the case of a disaster.

Furthermore, the controller 25 executes the information setting process by executing the setting information editing program. The information setting process is a process of making a setting to update the setting information on the radio 11 based on setting information acquired from another portable terminal device 12 or setting information generated by the setting information generation process. As described above, the controller 25 functions as an information setting unit 25c that executes the information setting process. Specifically, in the information setting process, based on the setting information, the controller 25 sets a type of a communication system, sets a frequency to be used, sets a group name of the radios 11, and sets a name of the individual radio 11.

With reference to FIGS. 3 to 5, a process performed by the communication terminal devices 8 in the case where a user who uses the communication system 1 newly forms a group will be described next. As illustrated in FIG. 3, the configuration of users before formation of a new group includes, for example, “Organization 1”, “Organization 2”, and “Organization 3” and users each belong to any one of organizations. “Organization 1” includes “User 1” to “User 5”. “Organization 2” includes “User 1” to “User 3”. “Organization 3” includes “User 1”. A newly-formed group is a group over a plurality of organizations and is, for example, a group consisting of “User 1” of “Organization 1”, “User 2” of “Organization 2”, and “User 1” of “Organization 3”. With reference to FIG. 4, the case where a group is newly created mainly by “User 1” of “Organization 3” will be described below.

As illustrated in FIG. 4, “User 1” of “Organization 1” operates the communication terminal device 8 including the radio 11 and the portable terminal device 12 in response to a call by “User 1” of “Organization 3”. “User 1” of “Organization 1” performs an operation for transmitting setting information on the radio 11 of “User 1” of “Organization 1” to the communication terminal device 8 of “User 1” of “Organization 3”. That is, the portable terminal device 12 of “User 1” of “Organization 1” executes the information exchange process. Specifically, upon receiving a user's operation by “User 1” of “Organization 1” via the UI unit 21 (step S1), the controller 25 acquires the setting information on the radio 11 from the storage unit 24, generates a two-dimensional code (QR) containing the setting information, and displays the generated two-dimensional code on a display of the UI unit 21 (step S2).

Thereafter, “User 1” of “Organization 3” performs an operation for receiving setting information on the radio 11 of “User 1” of “Organization 1”. That is, the portable terminal device 12 of “User 1” of “Organization 3” executes the information exchange process. Specifically, upon receiving a user's operation via the UI unit 21, the controller 25 reads a two-dimensional code displayed on the display of the UI unit 21 of the portable terminal device 12 of “User 1” of “Organization 1” using the imaging unit 23 (step S3) and acquires the setting information contained in the read two-dimensional code (i.e., converts the read two-dimensional code into the setting information) (step S4).

Similarly, “User 2” of “Organization 2” performs operation in response to a call from “User 1” of “Organization 3” and accordingly the portable terminal device 12 of “User 2” of “Organization 2” executes step S1 and step S2. The portable terminal device 12 of “User 1” of “Organization 3” executes step S3 and step S4 described above on the portable terminal device 12 of “User 2” of “Organization 2”.

The portable terminal device 12 of “User 1” of “Organization 3” repeatedly executes step S3 and step S4 described above for the number of the necessary communication terminal devices 8 of the users to be grouped. Thereafter, “User 1” of “Organization 3” performs an operation for newly generating setting information on the radios 11 that are used in the group. That is, the portable terminal device 12 of “User 1” of “Organization 3” executes the setting information generation process. Specifically, upon receiving a user's operation via the UI unit 21, the controller 25 executes the setting information generation process by executing the setting information editing program. The controller 25 performs data editing to generate new setting information based on pieces of setting information that are acquired from the other portable terminal devices 12 and the setting information of its own device 12 that is set previously and that is stored in the storage unit 24 (step S5). At step S5, the portable terminal device 12 of “User 1” of “Organization 3” transmits the generated new setting information to the communication management terminal device 6.

Thereafter, as at step S2, the portable terminal device 12 of “User 1” of “Organization 3” executes the information exchange process. Specifically, the controller 25 acquires the new setting information generated in the setting information generation process, generates a two-dimensional code containing the setting information, and displays the generated two-dimensional code on the display of the UI unit 21 (step S2). At that time, the portable terminal device 12 of “User 1” of “Organization 3” repeatedly executes step S2 described above for the number of the necessary communication terminal devices 8 of the users to be grouped.

Thereafter, “User 1” of “Organization 1” performs an operation for receiving the setting information on the radio 11 of “User 1” of “Organization 3”. That is, the portable terminal device 12 of “User 1” of “Organization 1” executes the information exchange process. Specifically, upon receiving a user's operation via the UI unit 21, the controller 25 reads the two-dimensional code displayed on the display of the UI unit 21 of the portable terminal device 12 of “User 1” of “Organization 3” using the imaging unit 23 and acquires the new setting information contained in the read two-dimensional code (step S6).

Upon acquiring the new setting information, the portable terminal device 12 of “User 1” of “Organization 1” executes the information setting process. Specifically, based on the acquired new setting information, the controller 25 makes an update setting on the setting information on the radio 11 (i.e., writes data in the radio 11) (step S7). At that time, the radio 11 makes a setting change to have a new group name of the radios 11 contained in the updated setting information and a new user configuration included in a new group (step S8). After execution of step S7, the portable terminal device 12 of “User 1” of “Organization 1” stores the new setting information also in the storage unit 24 of the portable terminal device 12 via the voice call application for making a voice call (step S9). In this manner, an update in the setting information in the communication terminal device 8 including the radio 11 and the portable terminal device 12 of “User 1” of “Organization 1” completes.

Like the portable terminal device 12 of “User 1” of “Organization 1” does, the portable terminal device 12 of “User 2” of “Organization 2” completes an update in the setting information in the communication terminal device 8 completes by executing steps S6 to S9.

Furthermore, like the portable terminal device 12 of “User 1” of “Organization 1” does, the portable terminal device 12 “User 1” of “Organization 3” completes an update in the setting information in the communication terminal device 8 based on the new setting information generated by the portable terminal device 12 of “User 1” of “Organization 3” itself by executing steps S6 to S9. The portable terminal device 12 of “User 1” of “Organization 3” only need to update the setting information based on the setting information generated by the portable terminal device 12 itself and therefore the portable terminal device 12 may omit step S6 and execute steps S7 to S9.

With reference to FIG. 5, a user configuration of the newly-formed group will be described next. As illustrated in FIG. 5, the setting information on the radios 11 is updated and thus the user configuration has, for example, the group name of “new temporally added group” and “User 1” of “Organization 1”, “User 2” of “Organization 2”, and “User 1” of “Organization 3” belong to this group. Note that the group name is editable to a given group name when setting information is generated and the name of the individual radio 11 is also editable to a given name at the time of generation of setting information.

As described above, according to the embodiment, the portable terminal device 12 is able to generate new setting information in consideration of setting information on other radios 11 and setting information on the radio 11 of its own device. The portable terminal device 12 is able to perform information exchange of newly generated setting information by performing the information exchange process described above. For this reason, even when the specifications of the radios 11 are different from each other, it is possible to promptly set up a communication environment for radio communication between the radios. Specifically, even when different groups gather and perform a cooperative work in an emergency, such as a disaster, it is possible to set a frequency and a group of the radios 11 promptly at an on-site level, establish a voice call environment of the group promptly, and start cooperative activities.

According to the present embodiment, it is possible to perform information exchange of setting information using at least one of a two-dimensional code, radio communication, and wired communication.

According to the present embodiment, because it is possible to transmit the new setting information to the communication management terminal device 6, the communication management terminal device 6 is able to manage the setting information of the communication terminal devices 8.

According to the present embodiment, it is possible to set a new frequency of the radios 11 in consideration of the frequency of other radios 11 and the frequency of the radio 11 of its own device. For this reason, even when the specifications of the radios 11 differ from each other, it is possible to set up a communication environment of radio communication between the radios.

According to the present embodiment, it is possible to provide the setting information editing program for editing setting information to the portable terminal device 12. For this reason, introducing the setting information editing program to the portable terminal device 12 makes it possible to update the setting information using the existing radio and the existing portable terminal device.

The present disclosure contributes to realization of “building infrastructure of industry and technological innovation” of SDGs and includes matters that contribute to creation of values by IoT solution.

According to the disclosure, it is possible to promptly set up a communication environment for radio communication between radios.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication terminal device comprising
a radio; and
a portable terminal device that is connected to the radio, wherein
the radio includes
a radio-side storage unit that stores setting information that is set for performing radio communication with another radio; and
a radio-side communication unit that executes group communication with the other radio based on the setting information, and
the portable terminal device includes
an information exchange unit that acquires, from a portable terminal device of another communication terminal device, setting information on a radio that is connected to the portable terminal device of the other communication terminal device;
a portable-terminal-device-side storage unit that stores the setting information on the radio of the other communication terminal device that is acquired by the information exchange unit;
a setting information generator that generates new setting information based on the setting information stored in the radio-side storage unit and the setting information stored in the portable-terminal-device-side storage unit when the setting information stored in the portable-terminal-device-side storage unit satisfies a given condition; and
an information setting unit that updates the setting information stored in the radio-side-storage unit of the radio based on the new setting information that is generated by the setting information generator.

2. The communication terminal device according to claim 1, wherein the setting information contains frequency information that is used by the radio for radio communication, and
the setting information generator generates the new setting information containing the frequency information for performing group communication based on the setting information stored in the radio-side storage unit and the portable-terminal-device-side storage unit.

3. The communication terminal device according to claim 1, wherein the portable terminal device further includes a portable-terminal-device-side communication unit that transmits the new setting information generated by the setting information generator to the portable terminal device of the other communication terminal device.

4. A non-transitory computer-readable storage medium storing a setting information editing program that is executed by a portable terminal device connected to a radio and that is for editing setting information set to perform radio communication with another radio, the program causing the portable terminal device to execute:
acquiring, from a portable terminal device of another communication terminal device, setting information on a radio that is connected to the portable terminal device of the other communication terminal device;
storing the setting information acquired from the radio connected to the portable terminal device of the other communication terminal device;
generating new setting information based on the setting information on the radio and the stored setting information when the stored setting information satisfies a given condition, and
updating the setting information on the radio based on the generated new setting information.
